(19) United States
(12) Patent Application Publication
(10) Pub. No.: US 2013/0121116 A1
(43) Pub. Date: May 16, 2013

(54) CONTROL APPARATUS FOR AN ELECTRONIC STOPWATCH

(71) Applicant: Yung Wen Lee, New Taipei City (TW)

(72) Inventor: Yung Wen Lee, New Taipei City (TW)

(73) Assignee: ECHOWELL ELECTRONIC CO., LTD., New Taipei City (TW)

(21) Appl. No.: 13/369,554

(22) Filed: Feb. 9, 2012

(30) Foreign Application Priority Data
Nov. 10, 2011 (TW) 100141124

(51) Int. Cl. G04G 5/00; G04B 19/24; G04B 19/22

(52) U.S. Cl. 368/21; 368/28; 368/51; 368/184

(57) ABSTRACT

The present invention provides an apparatus for controlling an electronic stop watch. The apparatus comprises a controller and a transmission media. The controller includes a keyboard for inputting a datum and an output port outputting the datum to the electronic stopwatch. The transmission media connects the electronic stopwatch with the controller, through one of a wire connection and a wireless connection.

### FIELD OF THE INVENTION

The present invention claims the benefits of priority from the Taiwanese Patent Application No. 100141124, filed on Nov. 10, 2011, the contents of the specification of which are hereby incorporated herein by reference. The present invention relates to an apparatus for controlling an electronic stopwatch, particularly an apparatus using either wired connection or wireless connection for conveniently operating the electronic stopwatch.

### BACKGROUND OF THE INVENTION

Functions of bicycle electronic stopwatches according to the prior art include monitoring, calculation and displaying, for example the ability of inputting the diameter of the wheels which is used for calculating some user-required calculation results such as the total riding distance, accumulated riding time and the total consumed energy (calorie) and displaying the calculation results on an LCD screen for the user to observe thereto conveniently. Depending on the gender and age of different users and the condition of the bike, some issues such as whether the electronic products are welcomed by the general public, whether the electronic products are able to perform calculation across different time zones and how the electronic products simultaneously set to several electronic stopwatches are to be encountered by the designer when initiating the concepts of personalized functions of an electronic stopwatch in accordance with different specifications of bicycles in the market. For the purpose of enhancing the product specifications of the current bicycle electronic stopwatches in terms of technology development, functional inspection and mass-production simultaneously, it is necessary to redesign the operating configuration of electronic stopwatches.

The specification of US patent publication numbered 2008/0191852A1 discloses the methods of performing monitoring on the wheel diameters of at least two bicycles and relevant data transmission, so as to provide an electronic stopwatch with settings regarding the wheel diameter, date, time and operational configuration. However, the mentioned invention is limited to the initialization operations of a single electronic stopwatch controlled by a controller only, which can simultaneously provide services to neither a variety of electronic stopwatches nor a plurality of electronic stopwatches.

According to the above-mentioned, there is a need for providing electronic stopwatches, which is applicable to different wheel diameters of bicycles, easy for production, reducing production time for being no need of manual setting during the production process and can be easily set by sellers, with a novel, easy for operating and expandable (for example, providing the physical status data such as heartbeat rate with the riding situation) controller. Besides, it can simplify the design of the electronic controller, and have the user be more concentrated to the displayed information on the screen to increase the efficiency as well as accuracy of the data initialization, if an electronic screen is employed for the display device when the system is being operated.

### SUMMARY OF THE INVENTION

To overcome the abovementioned defects of the prior art, the present invention provides an apparatus for controlling an electronic stopwatch. The present invention improves the efficiency of data transmission during the process of initialization with the aid of data encoding and wireless communication technologies. The technical scheme of the data transmission according to the present invention can performs settings to clock, users personal data, wheel diameter, total mileage and total riding time easily, provides a setting for the function of reminding to repair and maintenance, detects the battery condition, stores user's information, initializes the total amount of carbon-dioxide (TCO2) existing in blood plasma, the heart rate zone (HR Zone) and altitude, and adjusts the display-setting parameters of the LCD screen on the electronic stopwatch.

According to one embodiment of the present invention, the present provides an apparatus for controlling an electronic stopwatch. The apparatus comprises a controller and a transmission media. The controller includes a keyboard for inputting a datum and an output port outputting the datum to the electronic stopwatch. The transmission media connects the electronic stopwatch with the controller, through one of a wire connection and a wireless connection.

In accordance with another aspect of the present invention, a control apparatus having a controller is provided. The controller includes at least one of an outputting port and a transmission terminal. The outputting port transmits a datum inputted into the controller to an electronic stopwatch via a connection wire, and the transmission terminal transmits the datum to the electronic stopwatch via a wireless transmission.

In accordance with a further aspect of the present invention, an electronic stopwatch having a main body and an inputting port is provided. The inputting port is disposed on the main body of the electronic stopwatch, and for electrically connecting to a connection cable, so as to receive a datum through the connection cable into the main body of the electronic stopwatch.

The above objects and advantages of the present invention will be more readily apparent to those ordinarily skilled in the art after reading the details set forth in the descriptions and drawings that follow, in which:

### BRIEF DESCRIPTION OF THE DRAWINGS

FIG. 1 is a schematic diagram showing a control apparatus for a stopwatch in accordance with one embodiment of the present invention;

FIG. 2 is a schematic diagram showing an application configuration in accordance with one embodiment of the present invention employing the control apparatus illustrated in FIG. 1;

FIG. 3 illustrates a control apparatus for a stopwatch according to a further embodiment of the present invention;

FIGS. 4A to 4C are schematic diagrams showing configurations according to further embodiments of the present invention;

FIG. 5 is a schematic diagram showing a configuration of a wireless communication between a controller and a stopwatch;

FIGS. 6A and 6B are schematic diagrams illustrating the configurations according to a further embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

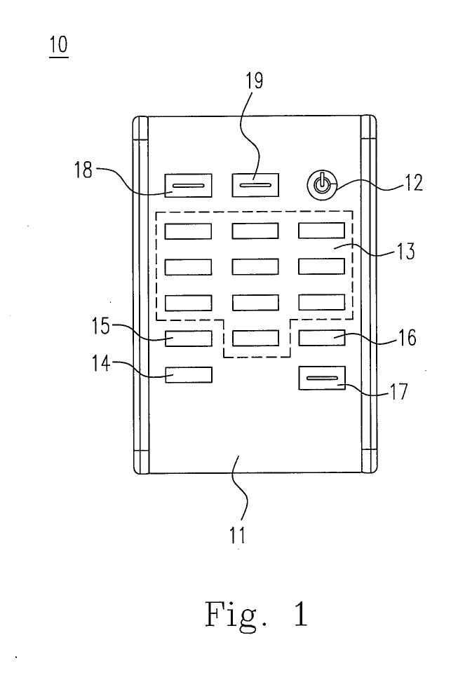

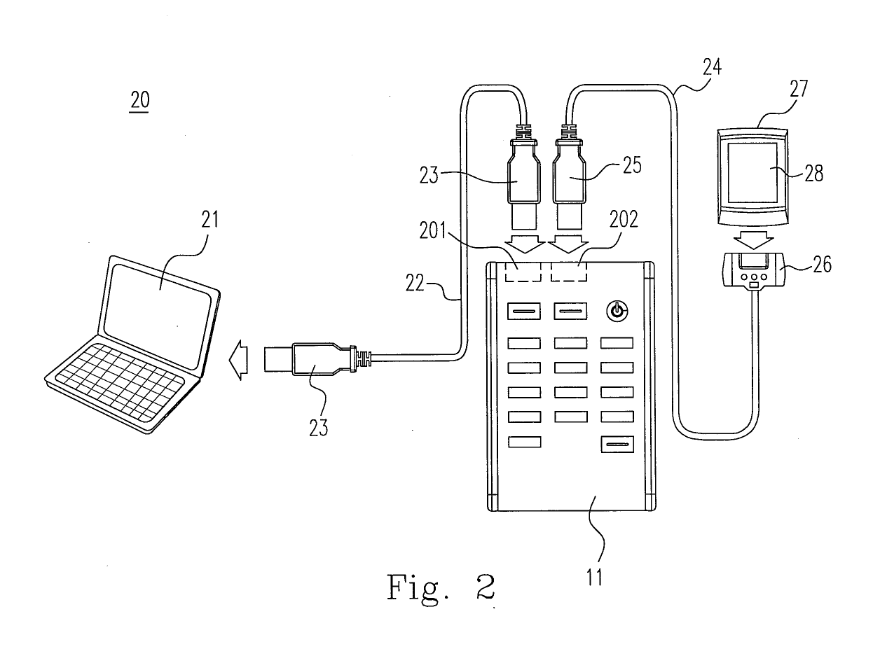

Please refer to FIGS. 1 and 2, which are schematic diagrams respectively showing a controller and a configuration in accordance with one embodiment of the present invention. According to FIG. 1, a main body of the controller 10 includes a housing 11 furnished with a plurality of keys or buttons including a power button 12, a key board 13 for the use of inputting digital data, a switching key 14 for selecting some inputted data, a return key 15, a delete button 16 for deleting the inputted data if any error exists therein, an entering button 17 for storing the inputted data, a time-setting hotkey 18 and a function hot-key 19. According to FIG. 2, a control apparatus 20 for an electronic stopwatch is illustrated therein. The control apparatus 20 comprises the controller 10, an electronic stopwatch 27 and a transmission media connecting the electronic stopwatch 27 with the controller 10. There is either a wire connection or a wireless connection (not shown) between the electronic stopwatch 27 and the controller 10. In a preferred embodiment, the controller 10 is electrically connected with a personal computer 21 via a USB connecting cable 22 having two USB plugs 23 at both ends thereof and a first USB receptacle 201 configured on the housing 11, so as to allow the personal computer 21 to calibrate the time and the date of the controller 10. The controller 10 may also be electrically connected with the electronic stopwatch 27 having a display screen 28 via another USB connecting cable 24 having a USB plug 25 at one end and a standard stopwatch connector bracket 26 at the other end and a second USB receptacle 202 configured on the housing 11, which allows a data transmission between the controller 10 and the electronic stopwatch 27, and does a user to control the settings inside of the electronic stopwatch 27 by operating the controller 10.

Notably the controller 10 has no display screen, since the controller 10 can take advantage of the display screen 28 for the use of displaying data by transmitting a modulated data steam (not shown) from the data to the stopwatch 27 via the serial connection illustrated in FIG. 2. Therefore, the controller 10 is a cost efficient design, which reduces the cost of configuring a display device on the controller 10 and simplifies the device structure of the controlling apparatus for a stopwatch. The present invention is also advantageous on being able to have the stopwatch display the data actually set in the stopwatch when initializing to avoid visual confusing of the user.

Again, referring to FIGS. 1 and 2, information relevant to external time can be manually input into the stopwatch 27 by operating the time-setting hotkey 18, and be recorded in the memory device (not shown) of the stopwatch 27. A variety of types of data for the need of operating the electronic stopwatch 27 are imbedded into the controller 10. One may request the electronic stopwatch 27 to display plural preset function codes by pressing the function hot-key 19.

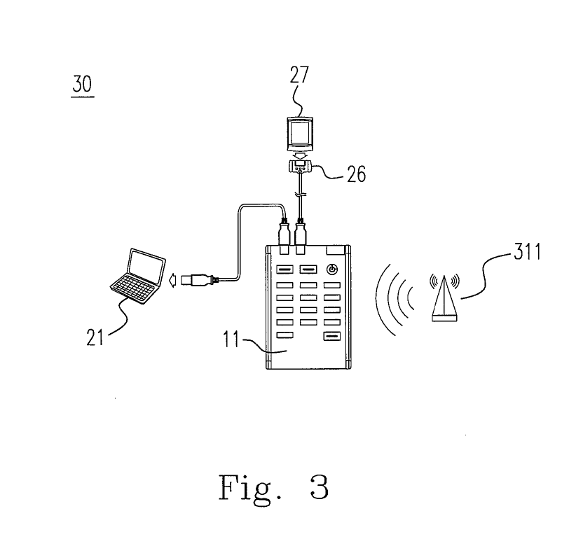

Please refer to FIG. 3, which illustrates a control apparatus for a stopwatch according to a further embodiment of the present invention. In addition to the configuration shown in FIG. 2, the control apparatus 30 further includes a radio-controlled clock 311 which is used for calibrating the internal time of the controller and adjusting the internal time according to different time zones. Therefore, the user may always see the correct time indicated by the stopwatch when traveling through different time zones.

According to the above, there are three different ways to adjust or calibrate the internal time of the controller 10. Firstly, one may use the computer 21 electrically connected to the controller 10 to calibrate the internal time of the controller 10. Secondly, one may manually input the time and date relevant data into the controller 10 by operating the time-setting hotkey 18. Thirdly, the time and date can be automatically adjusted by the radio-controlled clock 311 through a wireless communication.

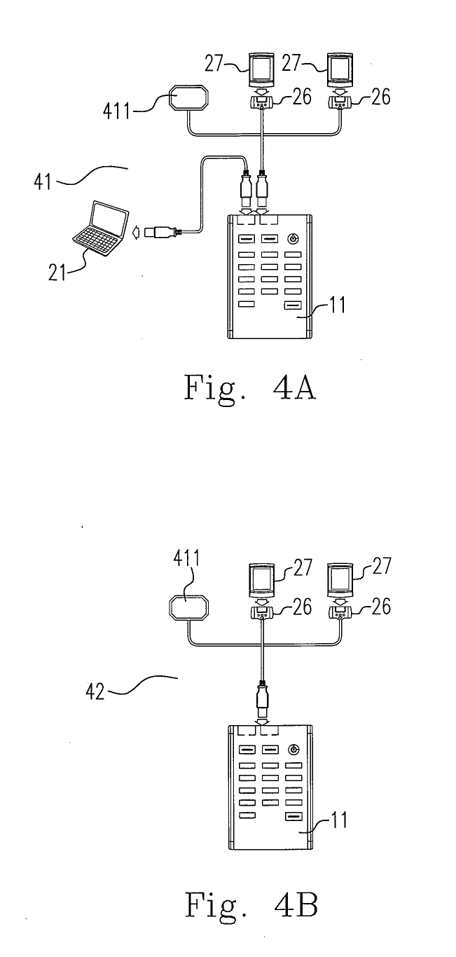

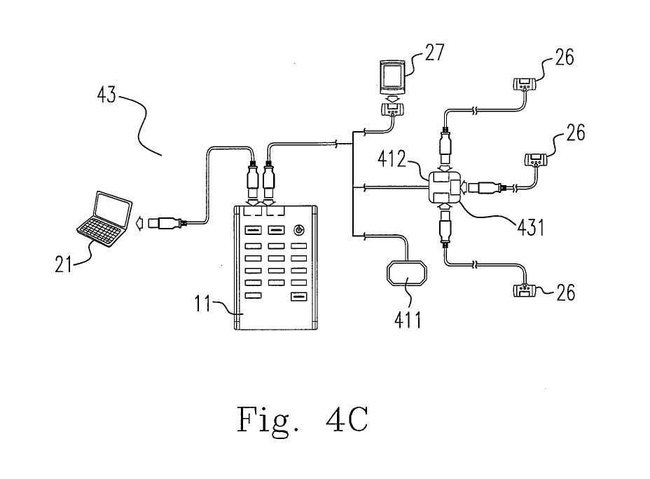

FIGS. 4A, 4B and 4C show configurations according to further embodiments of the present invention. According to FIG. 4A, a configuration 41 comprises a housing 11 of a controller 10, a computer 21 electrically connected with the housing 11, a plurality of stopwatches 27, each of which is electrically connected to the housing 11 via a standard stopwatch connector bracket 26, and a wireless transceiver 411 for providing a wireless communication with at least a stopwatch (not shown) and being an interface of wireless transmission for initialization data. The configuration 42 illustrated in FIG. 4B is similar to the configuration 41 in FIG. 4A except that the computer 21 is not used. According to FIG. 4C, the configuration 43 is based on the configuration 41 in FIG. 4A and a one-to-multipoint multiplexer 412 is employed for connection with a plurality of standard stopwatch connector bracket 26 which may be further connected to a plurality of stopwatches 27 (not shown). The skilled person in the art shall appreciates that there are transmission medias connecting the controller 10 with at least a stopwatch 27, and the transmission medias transmits data via either wire connections or wireless communications.

From a technical point of view, the control apparatus for an electronic stopwatch provided by the present invention make use of a personalized computer device, implements data updating for the shipping date and time of the electronic product, and transmits a user-inputted external datum, which is modulated into a data stream, from the controller 10 to the electronic stopwatch 27 via a serial connection. Such a transmission model is mainly applied to an electronic stopwatch disposed on a bicycle. The present invention provides efficient data transmission as well as program updating, which saves a lot of operation time.

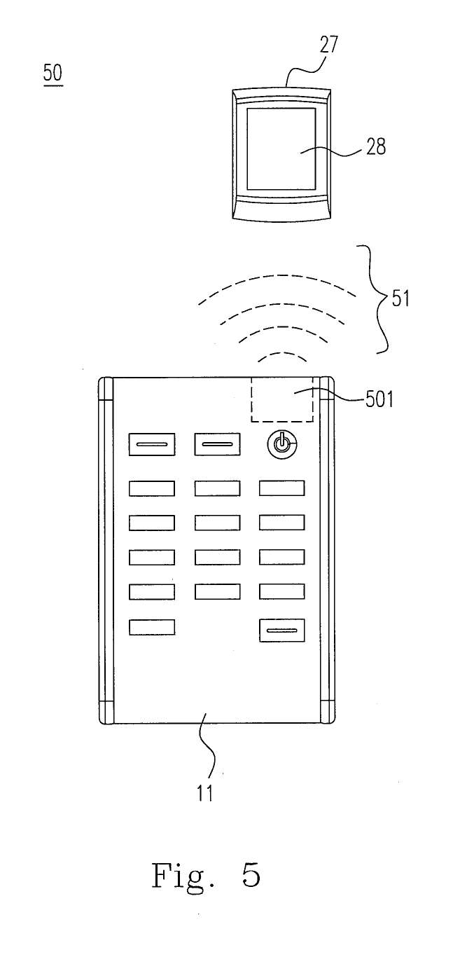

Please refer to FIG. 5, which schematics a configuration 50 of employing a wireless communication 51 between a housing 11 of a controller and a stopwatch 27 having a display 28. According to FIG. 5, a wireless signal outputting port 501 is configured on the housing 11. The configuration 50 is applicable for a multiplex structure which may be operated between the controller and a plurality of stopwatches 27. For the reason of simplicity, there is only one stopwatch 27 shown in the illustration of FIG. 5 as an example. The apparatus for controlling an electronic stopwatch provides by the present invention is able to set the parameters relevant to wheel diameter, time clock, user's data, total mileage, total riding time, the function of maintenance reminding, battery capacity, multiple user's information and etc. through either wired or wireless communication. Besides, the control apparatus can also initialize data such as the altitude measurement, total amount of carbon-dioxide (TCO2) existing in blood plasma, the heart rate zone (HR Zone) and altitude setting, and adjust the display-setting parameters of the LCD screen on the electronic stopwatch.

The wireless signal outputting port 501 configured on the housing 11 is used for establishing a data link with the plurality of electronic stopwatches 27, so as to control the settings (for example, the wheel diameter) inside the electronic stopwatches 27. Applicable methods for the wireless communication include transmission with phase array antennae and with laser 51. The transmission with phase array antennae provides broader coverage to the transmitted data, and is able to implement data transmission as well as initialization for plural electronic stopwatches 27 simultaneously, while the laser transmission usually provide broader available transmitting angle, and provides long-distance transmission to digitalized data.

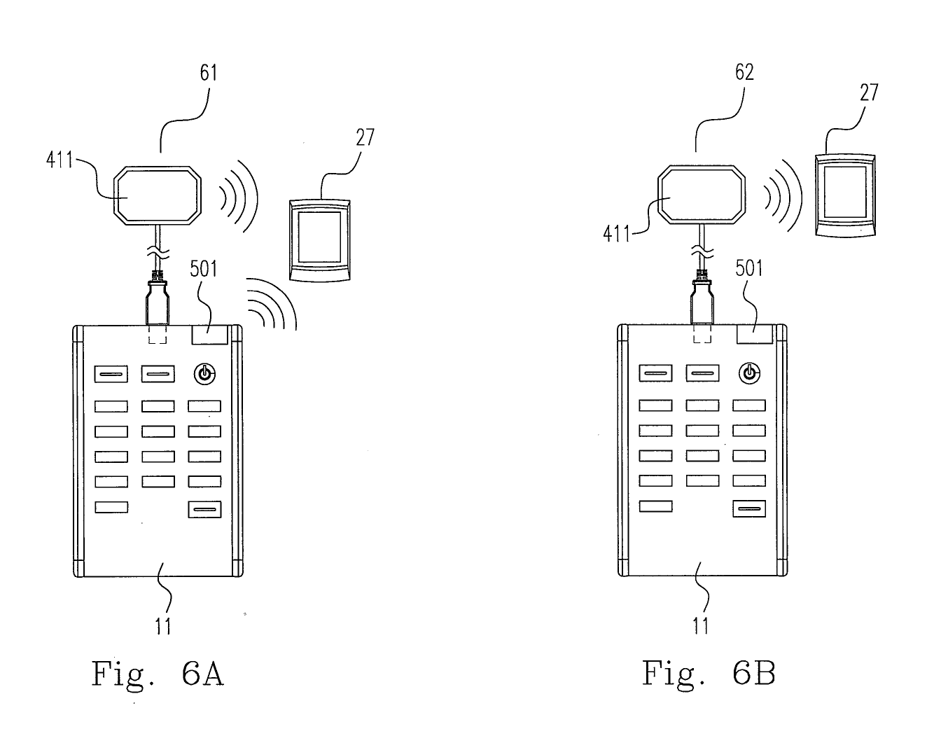

Referring to FIGS. 6A and 6B, which illustrates the configurations 61 and 62 respectively according to a further embodiment of the present invention, a wireless transceiver 411 is electrically connected with a housing 11 of a controller, and a wireless signal outputting port 501 is configured on the housing 11. In FIG. 6A, both the wireless transceiver 411 and the wireless signal outputting port 501 are able to contact the electronic stopwatch 27 through wireless connections. In FIG. 6B, only the wireless transceiver 411 contacts the electronic stopwatch 27 wirelessly.

According to a further embodiment of the present invention, the apparatus for controlling an electronic stopwatch may take advantage of the technology of integrated pulse-simulation data transmission to initiate a plurality of electronic stopwatches, determine the heartbeat rate of the user, operation situation and health condition, or initiate some basic data stored in the electronic stopwatch such as wheel diameter, date and time, use mode (language for example), and etc.

### EMBODIMENTS

1. An apparatus for controlling an electronic stop watch, comprising:

a controller including a keyboard for inputting a datum and an output port outputting the datum to the electronic stopwatch; and

a transmission media connecting the electronic stopwatch with the controller, through one of a wire connection and a wireless connection.

2. The apparatus of embodiment 1, wherein the controller has a time and a date thereon, and comprises a USB input port connected to a personal computer for calibrating the time and the date of the controller.
3. The apparatus of embodiment 1, wherein the controller has an internal time, and further comprises a radio-controlled clock calibrating the internal time of the controller, and adjusting the internal time according to different time zones.
4. The apparatus of embodiment 1, wherein the electronic stopwatch displays an external time, and the controller further comprises a time-setting hot key for manually setting the external time and recording the external time into the controller.
5. The apparatus of embodiment 1, wherein the controller is an electronic device without a display screen.
6. The apparatus of embodiment 1, wherein the controller transmits a modulated data stream to the electronic stopwatch via a serial connecting transmission.
7. The apparatus of embodiment 1, wherein the wire connection is performed through one of a two-point contact and a three-point contact.
8. The apparatus of embodiment 1, wherein the controller further includes a function key for indicating a plurality of pre-determined function codes on the electronic stopwatch.
9. The apparatus of embodiment 1, wherein the controller has a plurality of data types for operating the electronic stopwatch.
10. The apparatus of embodiment 1, controlling a plurality of electronic stopwatches, wherein the transmission media includes a one-to-multipoint multiplexer, the output port is coupled to the one-to-multipoint multiplexer, and the plurality of electronic stopwatches receive the datum from the controller via the one-to-multipoint multiplexer.
11. The apparatus of embodiment 1, wherein the transmission media includes a connection wire electrically connecting the output port and the electronic stopwatch or a wireless connection between the output port and the electronic stopwatch, so as to transmit the datum from the controller to the electronic stopwatch.
12. A control apparatus, comprising:

a controller including at least one of an outputting port and an transmission terminal, wherein:

the outputting port transmits a datum inputted into the controller to an electronic stopwatch via a connection wire; and

the transmission terminal transmits the datum to the electronic stopwatch via a wireless transmission.

13. The control apparatus of embodiment 12, wherein the controller has a time and a date thereon, and comprises a USB input port connected to a personal computer for calibrating the time and the date of the controller.
14. The control apparatus of embodiment 12, wherein the controller has an internal time, and further comprises a radio-controlled clock calibrating the internal time of the controller, and adjusting the internal time according to different time zones.
15. The control apparatus of embodiment 12, wherein the electronic stopwatch displays an external time, and the controller further comprises a time-setting hot key for manually setting the external time and recording the external time into the controller.
16. An electronic stopwatch, comprising:

a main body of the electronic stopwatch; and

an inputting port, disposed on the main body of the electronic stopwatch, and for electrically connecting to a connection cable, so as to receive a datum through the connection cable into the main body of the electronic stopwatch.

17. The electronic stopwatch of embodiment 16, wherein the main body has a time and a date thereon, and comprises a USB input port connected to a personal computer for calibrating the time and the date of the main body.
18. The electronic stopwatch of embodiment 16, wherein the main body has an internal time, and further comprises a radio-controlled clock calibrating the internal time of the main body, and adjusting the internal time according to different time zones.
19. The electronic stopwatch of embodiment 16, wherein the electronic stopwatch displays an external time, and the main body further comprises a time-setting hot key for manually setting the external time and recording the external time into the electronic stopwatch.
20. The electronic stopwatch of embodiment 16, wherein the input port receives a modulated data stream from a controller to the electronic stopwatch via a serial connecting transmission.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. An apparatus for controlling an electronic stopwatch, comprising:
a controller including a keyboard for inputting a datum and an output port outputting the datum to the electronic stopwatch; and
a transmission media connecting the electronic stopwatch with the controller, through one of a wire connection and a wireless connection.

2. An apparatus as claimed in claim 1, wherein the controller has a time and a date thereon, and comprises a USB input port connected to a personal computer for calibrating the time and the date of the controller.

3. An apparatus as claimed in claim 1, wherein the controller has an internal time, and further comprises a radio-controlled clock calibrating the internal time of the controller, and adjusting the internal time according to different time zones.

4. An apparatus as claimed in claim 1, wherein the electronic stopwatch displays an external time, and the controller further comprises a time-setting hot key for manually setting the external time and recording the external time into the controller.

5. An apparatus as claimed in claim 1, wherein the controller is an electronic device without a display screen.

6. An apparatus as claimed in claim 1, wherein the controller transmits a modulated data stream to the electronic stopwatch via a serial connecting transmission.

7. An apparatus as claimed in claim 1, wherein the wire connection is performed through one of a two-point contact and a three-point contact.

8. An apparatus as claimed in claim 1, wherein the controller further includes a function key for indicating a plurality of pre-determined function codes on the electronic stopwatch.

9. An apparatus as claimed in claim 1, wherein the controller has a plurality of data types for operating the electronic stopwatch.

10. An apparatus as claimed in claim 1, controlling a plurality of electronic stopwatches, wherein the transmission media includes a one-to-multipoint multiplexer, the output port is coupled to the one-to-multipoint multiplexer, and the plurality of electronic stopwatches receive the datum from the controller via the one-to-multipoint multiplexer.

11. An apparatus as claimed in claim 1, wherein the transmission media includes one of a connection wire electrically connecting the output port and the electronic stopwatch and a wireless connection between the output port and the electronic stopwatch, so as to transmit the datum from the controller to the electronic stopwatch.

12. A control apparatus, comprising:
a controller including at least one of an outputting port and an transmission terminal, wherein:
the outputting port transmits a datum inputted into the controller to an electronic stopwatch via a connection wire; and
the transmission terminal transmits the datum to the electronic stopwatch via a wireless transmission.

13. An apparatus as claimed in claim 12, wherein the controller has a time and a date thereon, and comprises a USB input port connected to a personal computer for calibrating the time and the date of the controller.

14. An apparatus as claimed in claim 12, wherein the controller has an internal time, and further comprises a radio-controlled clock calibrating the internal time of the controller, and adjusting the internal time according to different time zones.

15. An apparatus as claimed in claim 12, wherein the electronic stopwatch displays an external time, and the controller further comprises a time-setting hot key for manually setting the external time and recording the external time into the controller.

16. An electronic stopwatch, comprising:
a main body of the electronic stopwatch; and
an inputting port, disposed on the main body of the electronic stopwatch, and for electrically connecting to a connection cable, so as to receive a datum through the connection cable into the main body of the electronic stopwatch.

17. An electronic stopwatch as claimed in claim 16, wherein the main body has a time and a date thereon, and comprises a USB input port connected to a personal computer for calibrating the time and the date of the main body.

18. An electronic stopwatch as claimed in claim 16, wherein the main body has an internal time, and further comprises a radio-controlled clock calibrating the internal time of the main body, and adjusting the internal time according to different time zones.

19. An electronic stopwatch as claimed in claim 16, wherein the electronic stopwatch displays an external time, and the main body further comprises a time-setting hot key for manually setting the external time and recording the external time into the electronic stopwatch.

20. An electronic stopwatch as claimed in claim 16, wherein the input port receives a modulated data stream from a controller to the electronic stopwatch via a serial connecting transmission.
